(19) United States
(12) Patent Application Publication
(10) Pub. No.: US 2008/0304255 A1
(43) Pub. Date: Dec. 11, 2008

(54) Utility light with removable light arm

(76) Inventor: Gage C. Cauchois, Oakland, CA (US)

Correspondence Address: Peter J. Phillips;Cooper & Dunham LLP, 1185 Avenue of the Americas, New York, NY, 10036, US

(21) Appl. No.: 11/811,553

(22) Filed: Jun. 11, 2007

(51) Int. Cl. F21L 4/00

(52) U.S. Cl. 362/183

(57) ABSTRACT

A utility light comprising a light arm having two ends, an LED mounted on one end and a conductive plug mounted on the other end; a main housing which is adapted to contain a battery power source, a conductive socket for removeably receiving the conductive plug, a power control circuit, and cause the power control circuit to receive power from the battery power source only when conductive plug is in the conductive socket, and a power switch for connecting the power source to the battery power control circuit, said power switch adapted to control said power control circuit to output each of two different power levels for providing the LED with two different levels of light output illumination, and wherein said conductive socket includes a sensing switch to detect the presence of the conductive plug in the conductive socket.

### BACKGROUND OF THE INVENTION

The present invention relates to utility lights, and particularly to utility lights used as book lights or for task lighting.

Various utility lights have been used for booklights and task lighting. The utility lights typically have a housing and a light source. Many utility lights do not offer much if any flexibility in how the light source may be positioned or directed to a book page or to a task being worked on. Many utility lights have an integral light which may be unfolded or folded when not in use. If unfolded, the light is exposed and subject to damage. If folded, the light may still be exposed, or the overall folded structure may be bulky and cumbersome. Further, many utility lights have used incandescent lights using battery power which dim over time as battery power diminishes.

### SUMMARY OF THE INVENTION

The present invention is directed toward improving utility lights and to overcoming some of the disadvantages of prior art utility lights.

The invention provides a utility light comprising a light arm having two ends, an LED mounted on one end and a conductive plug mounted on the other end, and a main housing which is adapted to contain a battery power source, a conductive socket for removeably receiving the conductive plug, a power control circuit, and cause the power control circuit to receive power from the battery power source only when conductive plug is in the conductive socket, and a power switch for connecting the power source to the battery power control circuit, said power switch adapted to control said power control circuit to output each of two different power levels for providing the LED with two different levels of light output illumination, and wherein said conductive socket includes a sensing switch to detect the presence of the conductive plug in the conductive socket.

In a preferred embodiment the utility light comprises a light arm having two ends, an LED mounted on one end and a conductive plug mounted on the other end, wherein the LED is housed in a domed housing which also houses a circuit board to which the LED is mounted on one side, and a heat sink on the opposite side, wherein the domed housing has vent holes to dissipate heat from the heat sink, and wherein the domed housing is adapted to pivot with respect to the light arm; and a main housing which is adapted to contain a battery power source, a conductive socket for removeably receiving the conductive plug, a power control circuit, and cause the power control circuit to receive power from the battery power source only when conductive plug is in the conductive socket, and a power switch for connecting the power source to the battery power control circuit, said power switch adapted to control said power control circuit to output each of two different power levels for providing the LED with two different levels of light output illumination, and wherein said conductive socket includes a sensing switch to detect the presence of the conductive plug in the conductive socket, wherein the power switch is a three position switch, the three positions corresponding to no power, low power level lighting and high power level lighting, wherein the main housing is elongated and has receptacles along its side for storing the light arm when the conductive plug is not in the conductive socket, wherein the main housing has a spring clip in the form of a wire loop for mounting the main housing to an object, the main housing further including a power jack connected to the power control circuit for receiving a source of rectified AC power sufficient to power the control circuit in the absence of a battery power source, a battery bay for receiving at least one battery having two different poles, and battery connecting terminals adapted to connect to the battery only when the battery is properly loaded with a correct polarity position in the battery bay, and wherein the power control circuit provides a relatively constant level of power output over the substantially entire life of the battery source.

### BRIEF DESCRIPTION OF THE DRAWINGS

FIG. 1 is a perspective view of an assembled utility light according to an embodiment of the invention;

FIG. 1A is a perspective view of the light of FIG. 1, with the light rolled on its side;

FIG. 2 is an exploded view of the housing portion of the embodiment of FIG. 1;

FIG. 3 is an exploded view of the light post portion of the embodiment of FIG. 1, sometimes called an arm/lamp head;

FIG. 4A is an exploded view of the LED reflector assembly of the light post portion of the embodiment of FIG. 1, taken from a top perspective;

FIG. 4B is a view similar to that of FIG. 4A, but from a bottom perspective;

FIG. 5 is a circuit diagram of the electrical components of the embodiment of FIG. 1; and

FIG. 6 is a perspective view of the embodiment of FIG. 1 used to light the pages of an opened book.

### DESCRIPTION OF A PREFERRED EMBODIMENT

A description shall be given of a preferred embodiment of the invention, but the invention is not limited to the embodiment illustrated and described.

The invention provides a utility light comprising a light arm having two ends, an LED mounted on one end and a conductive plug mounted on the other end, and a main housing which is adapted to contain a battery power source, a conductive socket for removeably receiving the conductive plug, a power control circuit, and cause the power control circuit to receive power from the battery power source only when conductive plug is in the conductive socket, and a power switch for connecting the power source to the battery power control circuit, said power switch adapted to control said power control circuit to output each of two different power levels for providing the LED with two different levels of light output illumination, and wherein said conductive socket includes a sensing switch to detect the presence of the conductive plug in the conductive socket.

The power switch may be a three position switch, the three positions corresponding to no power, low power level lighting and high power level lighting. The main housing may be elongated and may have receptacles along its side for storing the light arm when the conductive plug is not in the conductive socket. The main housing may have a spring clip for mounting the main housing to an object. The spring clip may be a wire loop. The main housing may further include a power jack connected to the power control circuit for receiving a source of rectified AC power sufficient to power the control circuit in the absence of a battery power source. The LED may be housed in a domed housing which also houses a circuit board to which the LED is mounted on one side, and a heat sink on the opposite side. The domed housing may have vent holes to dissipate heat from the heat sink. The LED may be mounted in a domed housing which is connected to the light arm and pivot with respect to the light arm. The main housing may include a battery bay for receiving at least one battery having two different poles, and battery connecting terminals adapted to connect to the battery only when the battery is properly loaded with a correct polarity position in the battery bay. The power control circuit may provide a relatively constant level of power output over the substantially entire life of the battery source.

In a preferred embodiment the utility light comprises a light arm having two ends, an LED mounted on one end and a conductive plug mounted on the other end, wherein the LED is housed in a domed housing which also houses a circuit board to which the LED is mounted on one side, and a heat sink on the opposite side, wherein the domed housing has vent holes to dissipate heat from the heat sink, and wherein the domed housing is adapted to pivot with respect to the light arm; and a main housing which is adapted to contain a battery power source, a conductive socket for removeably receiving the conductive plug, a power control circuit, and cause the power control circuit to receive power from the battery power source only when conductive plug is in the conductive socket, and a power switch for connecting the power source to the battery power control circuit, said power switch adapted to control said power control circuit to output each of two different power levels for providing the LED with two different levels of light output illumination, and wherein said conductive socket includes a sensing switch to detect the presence of the conductive plug in the conductive socket, wherein the power switch is a three position switch, the three positions corresponding to no power, low power level lighting and high power level lighting, wherein the main housing is elongated and has receptacles along its side for storing the light arm when the conductive plug is not in the conductive socket, wherein the main housing has a spring clip in the form of a wire loop for mounting the main housing to an object, the main housing further including a power jack connected to the power control circuit for receiving a source of rectified AC power sufficient to power the control circuit in the absence of a battery power source, a battery bay for receiving at least one battery having two different poles, and battery connecting terminals adapted to connect to the battery only when the battery is properly loaded with a correct polarity position in the battery bay, and wherein the power control circuit provides a relatively constant level of power output over the substantially entire life of the battery source.

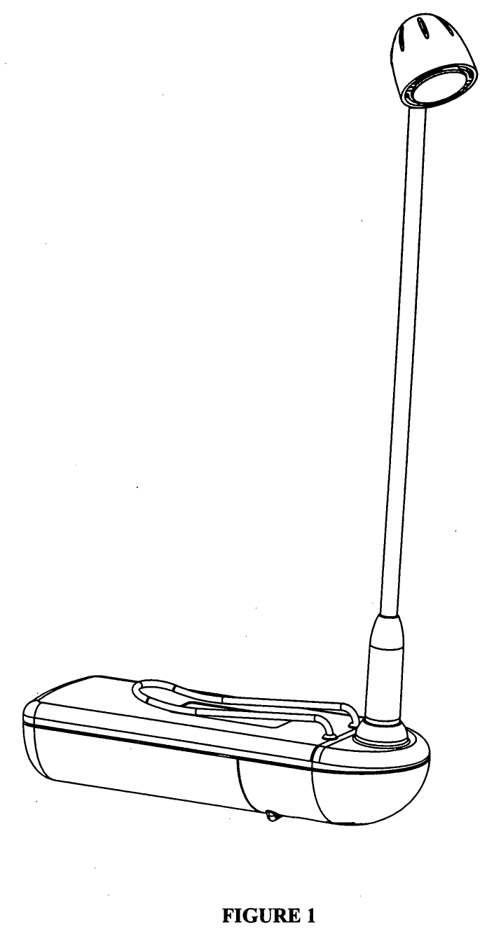

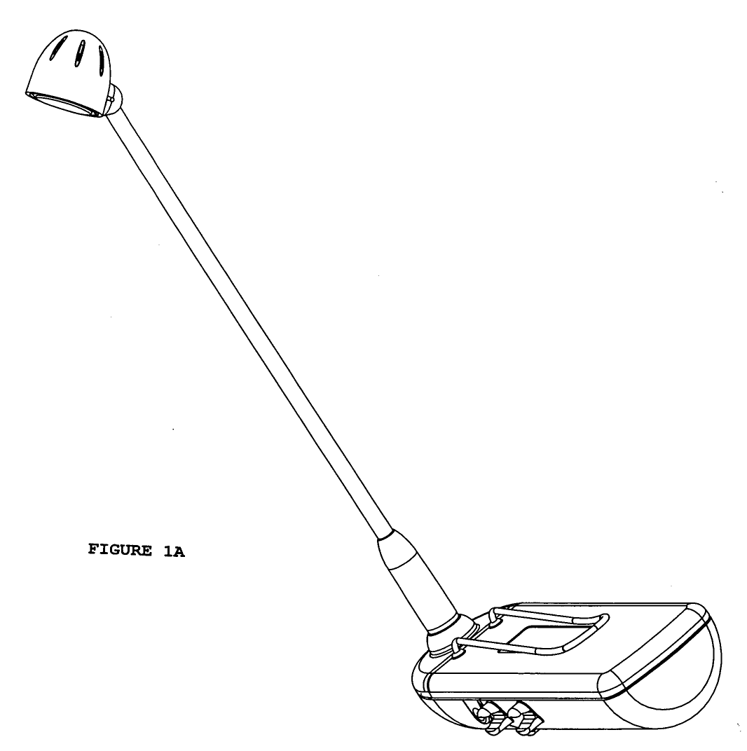

FIG. 1 shows a utility light having a main housing and a removable light post or arm. This Figure shows the utility light with one face of the housing lying on a horizontal surface, with the light post extending vertically upward. The light is in a reflector assembly in the top of the light post. The utility light can be used as a mini-desk lamp or work lamp to provide general or task lighting. The light may also be used as a book light by attaching the light to a cover or pages of a book.

Because the light post or arm is removable, it can be replaced if it becomes damaged or over time it loses its full illumination capability, so one need only replace the light arm instead of the entire utility light. While the light element of the preferred embodiment is an LED which provides white light, different light arms having different colors may be provided and can be interchanged.

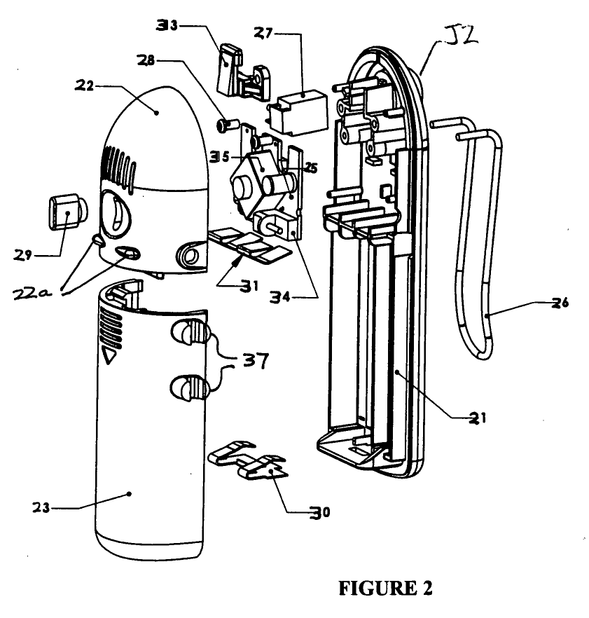

FIG. 2 shows the housing portion of the utility light in exploded view. The housing comprises a base side 21, an upper cover 22 and a lower battery cover 23. These parts may be made of ABS. A printed circuit board (PCB) assembly or module 25 is received in the top of the housing. A formed wire clip 26, which may be made of stainless steel, is mounted in the rear of the housing base side in two reinforced holes in the base side, and may be held in place by epoxy. A PCB mount 27 which is available from Technik Socket, is also mounted in the housing base side. Two screws 28 may be used to hold the PCB module 25 in place. A switch button 29, which may be of ABS, is adapted to extend through the upper cover 22 and activate a push button switch 35, (available from Canal) on the PCB module 25.

The base side housing in its lower region is adapted to receive two AA batteries in a battery bay. A bottom battery common terminal 30 (of stainless steel) is mounted at the very bottom of the base side of the housing and a top battery clip 31 (of Ni-plated brass) is mounted at the top of the battery bay. At the top of the battery bay are battery polarity tabs which prevent battery power from being delivered to the PCB module 25 if the batteries are loaded in the incorrect polarity position, to prevent possible damage to the PCB components.

Specifically, a polarity-tab will keep the flat negative terminal of a AA battery from reaching the top battery clip 31, and will permit only the positive post terminal of an AA battery to contact the electrical terminal of the top battery clip 31.

A socket brace (ABS) 33 is mounted in the top part of the base side, and receives one end of the light arm. A power input socket 34 enables power to be delivered to the PCB from the output plug of a transformer (not shown), so that the unit can be operated without the use of battery power. When all of the components are mounted in the housing, the upper cover maybe bonded to the top of the base side of the housing. The battery cover 23 may be removed to replace batteries. The battery cover has two snap-in arm grippers or receptacles 37 to enable storage of the light post or arm 40 when not in use.

The upper cover 22 and battery cover 23 each have a rounded curved surface. The upper cover 22 has stabilizer legs 22a which keep the housing from rolling over when in the position shown in FIG. 1. However, the housing can be rolled on its side and the grippers 37 can serve as stabilizers, as shown in FIG. 1A. The light post can be oriented in any radial position in the socket 34. If the housing is rolled on its side and stabilized by grippers 37, the light post will be angled relative to vertical and the post can be rotated within the socket 34 to direct the LED to a desired target.

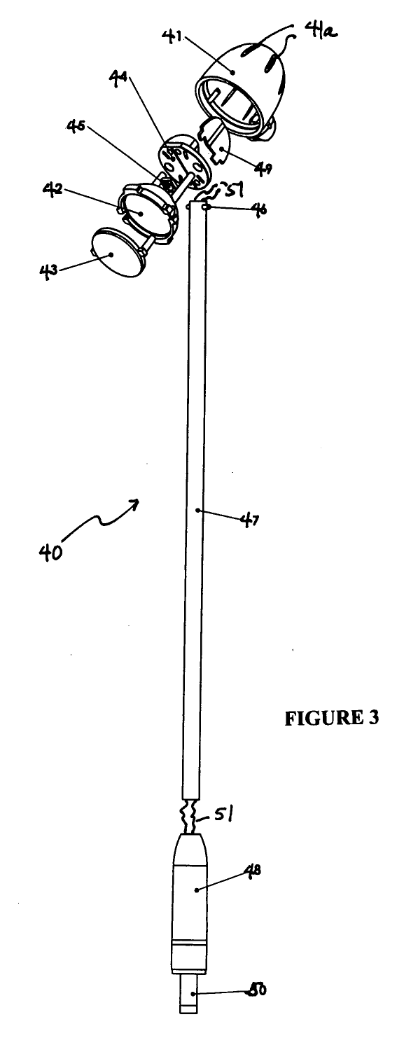

FIG. 3 shows the light post or arm 40. The light arm 40 has a reflector shell 41 (ABS), an LED reflector 42 (ABS), a cover lens (polycarbonate or PC), an LED printed circuit board heat sink 44, made of 1 mm FR-4 dual layer copper, an LED (Nichia NFSW 036 BT) 45, a retaining pin 46 (stainless), a tube arm 47 (4 mm OD stainless), an arm plug cap 48 (ABS); heat sink fins 49 (tinned copper), and a connection plug 50 (4 mm coaxial power plug from Morenthal). Wires inside the tube arm 47 connect the connection plug 50 to the LED PCB 44 and LED 45. The reflector shell 41 has vent holes 41a which allow heat to escape when the LED 45 is powered on. The heat sink fins 49 draw heat from the LED 45 and bring the heat close to the vent holes. The retaining pin 46 at the end of the tube arm 47 is received inside holes in the outer reflector shell 41.

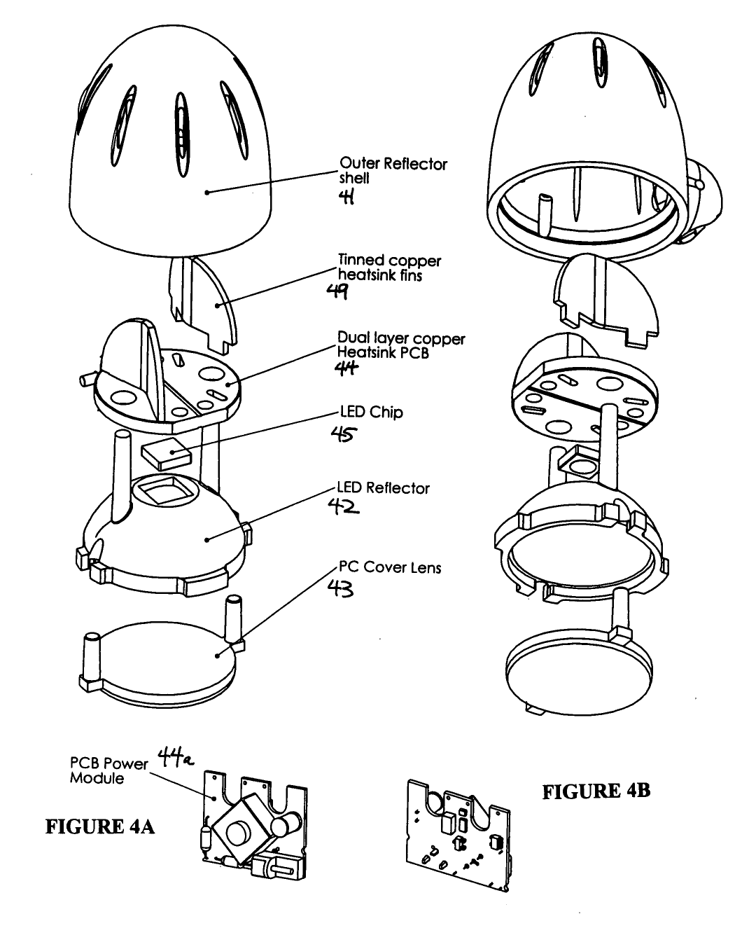

FIGS. 4A and 4B show the top part of the reflector assembly part of the light arm in greater detail. The LED 45 is arranged in an LED chip. The arrangement of the components on the PCB 44a is shown in closer detail.

Also, because the light post is replaceable, it could be upgraded as a more efficient or more powerful LED and chip become available.

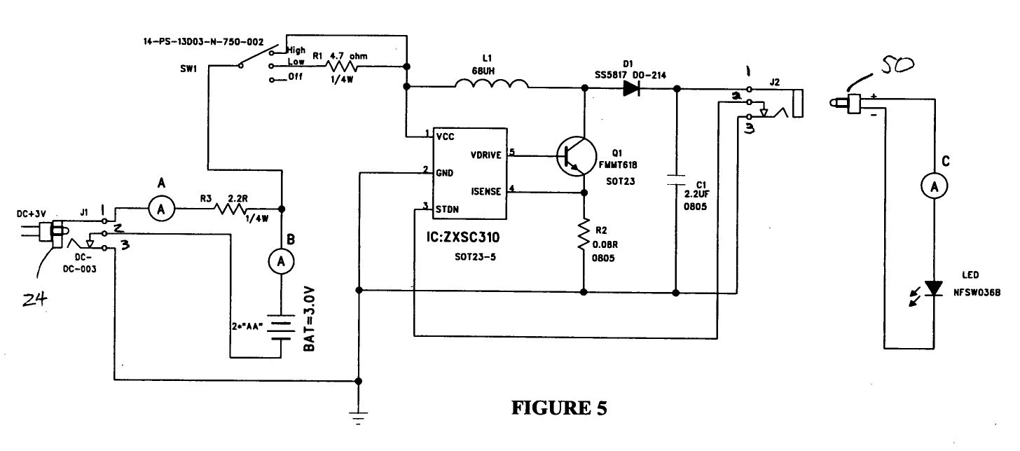

FIG. 5 shows the electrical components for the preferred embodiment. Shown at the left is the jack 24 for receiving optionally a 3 VDC power source. If a 3 VDC power source is fully inserted into jack 24, the battery supply is disconnected from the circuit because pins 2 and 3 will be disconnected. The 3 VDC power source if provided would pass across input resistor R3 (2.2 Kohms) and to switch SW1, which is the same as switch 25 in FIG. 2. This switch 25 has three positions, cycling through a high position, low position and off position with each depression of the switch. In the high position all power by pass the R1 resistor (4.7 ohms) whereas in the low position the power goes across the R1 resistor. The power is fed to the VEC terminal of an IC driver chip is connected to the base of a drive transistor Q1 (FMMT618). Connected to collector terminal of the transistor Q1 is an inductor L1 (68 uH) and a diode D1 (555817). Connected to the emitter of the transistor Q1 is a resistor RZ (0.08 k ohms) to circuit ground. A capacitor C1 (2.2 UF) is connected between the diode D1 and circuit ground.

Shown on the right of the circuit is a circuit representation of the light arm, including the LED 45 (NFSW136B) and the plug 50. When the plug 50 is inserted into the jack J2 (which jack is exposed on the rear face of the base side housing 11 as shown in FIG. 2), terminals 1 and 3 of the jack are connected respectively to the plus (+) and minus (−) of the light arm plug. Terminal 2 will not be connected to circuit ground, and the IC driver chip will provide power to the transistor Q1. This represents an “operative” or “load” condition of the circuit, and appropriate power will be provided to J2 and plug 50 to drive LED to either a high or low illumination, depending on the position of switch SW1. However, if plug 50 is not fully received in jack J2, pin 2 will be connected to pin 3, bringing the STDN terminal of IC Driver chip to ground, resulting in no output power to drive transistor Q1. This represents a “no load” condition, and circuit components are not needlessly driven. The circuit points marked A, B and C represent test points and can be ignored.

The IC driver circuit will output a steady level of voltage at the VDRIVE pin when SW1 is in the high position, regardless of the battery voltage, as long as the battery voltage is above a certain minimum voltage. This results in a steady illumination of the LED, without drop off as the batteries reach a certain power. When the batteries reach a certain bottom power level where it can no longer sufficiently drive the IC driver to illuminate LED at that constant illumination, IC driver stops driving the transistor Q1 and the LED do not illuminate. The same operation is true when the switch sw1 is in the low position, in which case the LED is always illuminated at the lower illumination level until the batteries drop in output below the minimum operating voltage. Advantageously, this results in the LED always outputting a constant illumination level, unlike some lights which slowly dim over time, resulting in user eyestrain from poor lighting conditions common in incandescent lighting arrangements and flashlights.

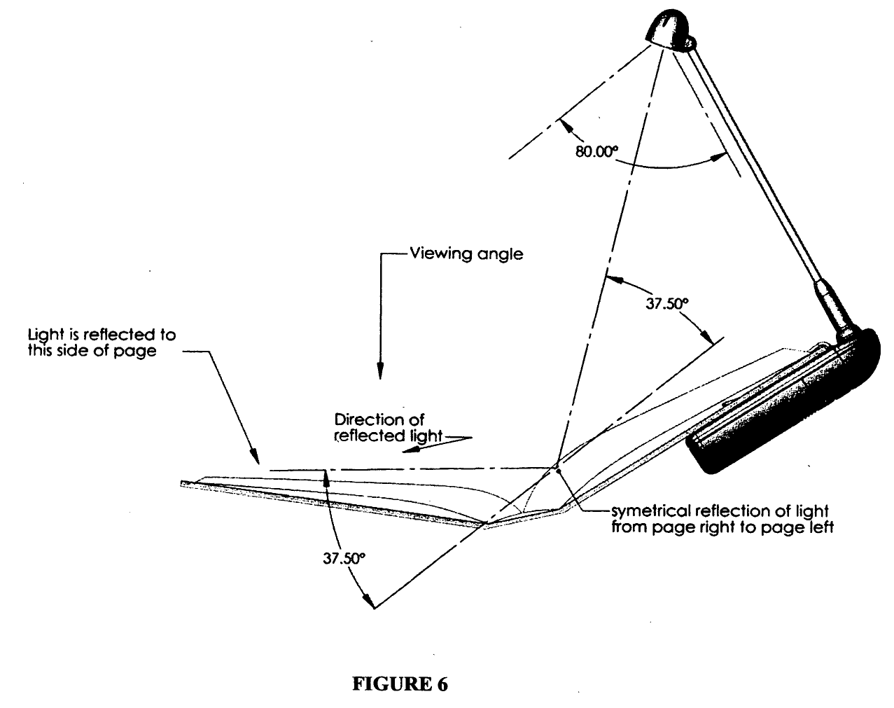

FIG. 6 shows the device attached to the right edge cover of a book. The LED reflector is positioned at a certain high arch position near the page binding and some of the light is advantageously reflected across the opposite page. The output illumination angle of the reflector and LED according to the preferred embodiment is 80° as shown, and the center of illumination forms a 37.5° angle with the baseline, which baseline is roughly parallel with the line representing the outer range of the 80° illumination of the reflector and LED. Also, the open angle of the book is such that a 37.5° angle is formed between the base line and the far page of the book, as shown.

Thus, by adjusting the centerline of the illumination range of the LED and reflector away from the closest page and more toward the high are point shown in the FIG. 6, the light will be more evenly distributed across both the near and far pages of the open book. Further adjustment of the light on the far page can be accomplished by changing the open angle of the book. Also, by placing the housing on the side edge of the book instead of the top edge of the book, the light reflected back to the reader's eyes is reduced thereby increasing comfort to the reader. The LED and reflector are arranged to provide an even level of illumination across the entire 80° range of illumination. Various modifications can be made to the embodiments of the present invention herein described without departing from the spirit thereof. The above description should not be construed as limiting the invention, but merely as exemplifications of preferred embodiments thereof. Those skilled in the art will envision other modifications within the scope and spirit of the present invention as defined by the claims appended hereto.

1. A utility light comprising:
a light arm having two ends, an LED mounted on one end and a conductive plug mounted on the other end;
a main housing which is adapted to contain a battery power source, a conductive socket for removeably receiving the conductive plug, a power control circuit, and cause the power control circuit to receive power from the battery power source only when conductive plug is in the conductive socket, and a power switch for connecting the power source to the battery power control circuit, said power switch adapted to control said power control circuit to output each of two different power levels for providing the LED with two different levels of light output illumination, and wherein said conductive socket includes a sensing switch to detect the presence of the conductive plug in the conductive socket.

2. The utility light according to claim 1, wherein the power switch is a three position switch, the three positions corresponding to no power, low power level lighting and high power level lighting.

3. The utility light according to claim 1, wherein the main housing is elongated and has receptacles along its side for storing the light arm when the conductive plug is not in the conductive socket.

4. The utility light according to claim 1, wherein the main housing has a spring clip for mounting the main housing to an object.

5. The utility light according to claim 4, wherein the spring clip is a wire loop.

6. The utility light according to claim 1, wherein the main housing further includes a power jack connected to the power control circuit for receiving a source of rectified AC power sufficient to power the control circuit in the absence of a battery power source.

7. The utility light according to claim 1, wherein the LED is housed in a domed housing which also houses a circuit board to which the LED is mounted on one side, and a heat sink on the opposite side.

8. The utility light according to claim 7, wherein the domed housing has vent holes to dissipate heat from the heat sink.

9. The utility light according to claim 1, wherein the LED is mounted in a domed housing which is connected to the light arm and pivot with respect to the light arm.

10. The utility light according to claim 1, wherein the main housing includes a battery bay for receiving at least one battery having two different poles, and battery connecting terminals adapted to connect to the battery only when the battery is properly loaded with a correct polarity position in the battery bay.

11. The utility light according to claim 1, wherein the power control circuit provides a relatively constant level of power output over the substantially entire life of the battery source.

12. A utility light comprising:
a light arm having two ends, an LED mounted on one end and a conductive plug mounted on the other end, wherein the LED is housed in a domed housing which also houses a circuit board to which the LED is mounted on one side, and a heat sink on the opposite side, wherein the domed housing has vent holes to dissipate heat from the heat sink, and wherein the domed housing is adapted to pivot with respect to the light arm;
a main housing which is adapted to contain a battery power source, a conductive socket for removeably receiving the conductive plug, a power control circuit, and cause the power control circuit to receive power from the battery power source only when conductive plug is in the conductive socket, and a power switch for connecting the power source to the battery power control circuit, said power switch adapted to control said power control circuit to output each of two different power levels for providing the LED with two different levels of light output illumination, and wherein said conductive socket includes a sensing switch to detect the presence of the conductive plug in the conductive socket, wherein the power switch is a three position switch, the three positions corresponding to no power, low power level lighting and high power level lighting, wherein the main housing is elongated and has receptacles along its side for storing the light arm when the conductive plug is not in the conductive socket, wherein the main housing has a spring clip in the form of a wire loop for mounting the main housing to an object, the main housing further including a power jack connected to the power control circuit for receiving a source of rectified AC power sufficient to power the control circuit in the absence of a battery power source, a battery bay for receiving at least one battery having two different poles, and battery connecting terminals adapted to connect to the battery only when the battery is properly loaded with a correct polarity position in the battery bay, and wherein the power control circuit provides a relatively constant level of power output over the substantially entire life of the battery source.
